(19) United States
(12) Patent Application Publication
(10) Pub. No.: US 2014/0153066 A1
(43) Pub. Date: Jun. 5, 2014

(54) DOCUMENT SCANNING SYSTEM WITH TRUE COLOR INDICATOR

(71) Applicants: Sarasin Booppanon, Bangkok (TH); Chanwut Sangsok, Bangkok (TH); Supichai Kantrasiri, Bangkok (TH); Surachat Buplub, Bangkok (TH)

(72) Inventors: Sarasin Booppanon, Bangkok (TH); Chanwut Sangsok, Bangkok (TH); Supichai Kantrasiri, Bangkok (TH); Surachat Buplub, Bangkok (TH)

(21) Appl. No.: 14/028,540

(22) Filed: Sep. 17, 2013

Related U.S. Application Data
(63) Continuation-in-part of application No. 13/776,712, filed on Feb. 26, 2013, now Pat. No. 8,559,063.
Application No. 13/776,712 is a continuation-in-part of application No. 13/690,487, filed on Nov. 30, 2012, now abandoned.

(51) Int. Cl. H04N 1/10

(52) U.S. Cl. CPC H04N 1/10
USPC 358/483

(57) ABSTRACT

Disclosed are systems, methods, and/or apparatus to scan a document and capture the true color of the scanned document. In one embodiment, a document scanning system may include a base element having a document placement deck, one or more supporting elements coupled to the base element, and one or more lighting elements coupled to the one or more supporting elements. In addition, the document scanning system may comprise a polychromatic color chart comprising a true color indicator element. In another embodiment, a document scanning system may include a base element, a neck element, a doublet of lighting arms, a docking head, and an image capture device. In this embodiment, the base element may comprise a document placement deck and a polychromatic color chart positioned on the document placement deck.

### CLAIM OF PRIORITY

This non-provisional application is a continuation-in-part (CIP) application of co-pending U.S. patent application Ser. No. 13,776,712, filed on Feb. 26, 2013 and which is hereby incorporated by reference in its entirety, which, in turn is a CIP application of formerly co-pending U.S. patent application Ser. No. 13/690,487, filed on Nov. 30, 2012.

### FIELD OF TECHNOLOGY

This disclosure relates generally to the field of document scanning, more specifically, to systems, methods, and/or apparatus to capture the true color of a scanned document.

### BACKGROUND

Scanning text and graphics from books, magazines, and/or other paper based documents, into an electronic format for analysis, distribution, and archiving, has often been the functional domain of flatbed scanners. Such flatbed scanners may provide a controlled environment by using a lid component to isolate the document and shield it from external optical factors, such as light and glare. While such an optically controlled environment may improve the color quality of such scans, the need for such lids may present a challenge when scanning pages from oversized books or magazines. Other popular types of scanners include sheet-fed scanners which offer the advantage of automatic sheet-feeding over flatbed scanners. However, to accommodate such sheet-feeders, bounded materials (e.g., books, magazines, etc.) must be unbound by breaking the spine of the book or magazine to obtain the individual pages separately.

More recently, mobile devices such as smartphones and tablet devices have begun to replace traditional scanners for users seeking a quick on-the-go scan. However, scans made by such devices are often done in an uncontrolled environment where light and glare adversely affect the document scanned. In addition, the native camera applications on such mobile devices are often unable to produce an image with accurate photometric color and with correct geometric aspect ratios. Thus, a mobile device alone may be unable to capture scans of comparable quality as those generated by conventional flatbed or sheet-fed scanners.

### SUMMARY

Disclosed are systems, methods, and/or apparatus to scan a document and capture the true color of the scanned document. In one aspect, a document scanning system may include a base element having a document placement deck, one or more supporting elements coupled to the base element, and one or more lighting elements coupled to the one or more supporting elements. In this aspect, the one or more lighting elements may be non-planar and may emit a total light color temperature of between 4,100 to 5,900 Kelvin. In this aspect, each of the one or more lighting elements may be positioned equidistant with respect to a center point on the document placement deck and the one or more lighting elements may generate a combined brightness output on a top surface of the document placement deck of between 1,500 to 2,500 lux.

Additionally, in this aspect, one or more image capture devices may be coupled to the one or more supporting elements of the document scanning system and may be positioned above the document placement deck and configured to capture an image of a document. Moreover, the document scanning system may comprise a polychromatic color chart comprising a true color indicator element. In this aspect, a data processing device communicatively coupled to the document scanning system may be configured to use the polychromatic color chart to determine a true color of the image captured.

In another aspect, a document scanning system may include a base element, a neck element, a doublet of lighting arms, a docking head, and an image capture device. In this aspect, the base element may comprise a document placement deck and a polychromatic color chart positioned on the document placement deck. In addition, the polychromatic color chart may comprise a true color indicator element. Moreover, the neck element may be positioned at a fixed distance from the document placement deck and may comprise a head end and a base end. In this aspect, the neck element may be coupled to the base element at the base end. Also in this aspect, the doublet of lighting arms may be positioned at a fixed distance from the document placement deck and may comprise a first lighting arm and a second lighting arm.

In this aspect, the first lighting arm and the second lighting arm may be coupled to either the base element or the neck element and may be positioned above the base element. In addition, the first lighting arm may comprise at least one first lighting element coupled to the first lighting arm and the second lighting arm may comprise at least one second lighting element coupled to the second lighting arm. Furthermore, the docking head may be coupled to the head end of the neck element and may comprise an image capture opening and a docking cradle. Moreover, the image capture device may be positioned in the docking cradle and may have a user interface face of the image capture device directed away from the document placement deck and an image capture lens directed toward the document placement deck through the image capture opening to capture a scanned image.

The methods and systems disclosed herein may be implemented by any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

FIG. 1 illustrates a system view of a document scanning system, according to one or more embodiments.

FIG. 2 illustrates a close up view of the document scanning system of FIG. 1 communicatively coupled to a data processing device, according to one or more embodiments.

FIG. 3 illustrates a schematic of an auto capture unit of the document scanning system of FIG. 1, according to one or more embodiments.

FIG. 4 illustrates the document scanning system of FIG. 1 in operation, according to one or more embodiments.

FIG. 5 illustrates an up close view of the document placement deck of the document scanning system of FIG. 1, according to one or more embodiments.

FIG. 6 is a colored drawing of an exemplary polychromatic color chart used by the document scanning system of FIG. 1, according to one or more embodiments.

FIG. 7 illustrates an exemplary user interface of a scanning program run by the document scanning system of FIG. 1, according to one or more embodiments.

FIG. 8 is a perspective view of a document scanning system, according to one or more embodiments.

FIG. 9 is a colored drawing of a document placement deck of the document scanning system of FIG. 8 comprising a polychromatic color chart, according to one or more embodiments.

FIG. 10 is a flow chart depicting exemplary operations undertaken by the document scanning system of FIG. 1, according to one or more embodiments.

FIG. 11 is a flow chart depicting exemplary operations undertaken by the document scanning system of FIG. 8, according to one or more embodiments.

Other features of the present embodiments will be apparent from the accompanying drawings and from the detailed description that follows.

### DETAILED DESCRIPTION

Disclosed are methods, devices, and systems to scan a document and capture the true color of the scanned document. Although the present embodiments have been described with reference to specific example embodiments, it will be evident that various modifications and changes may be made to these embodiments without departing from the broader spirit and scope of the various embodiments. It should be understood by one of ordinary skill in the art that the terms “application(s),” “program(s),” “software,” “software code,” “sub-program(s),” and “block(s)” are industry terms that refer to computing instructions stored in memory and executable by one or more processors.

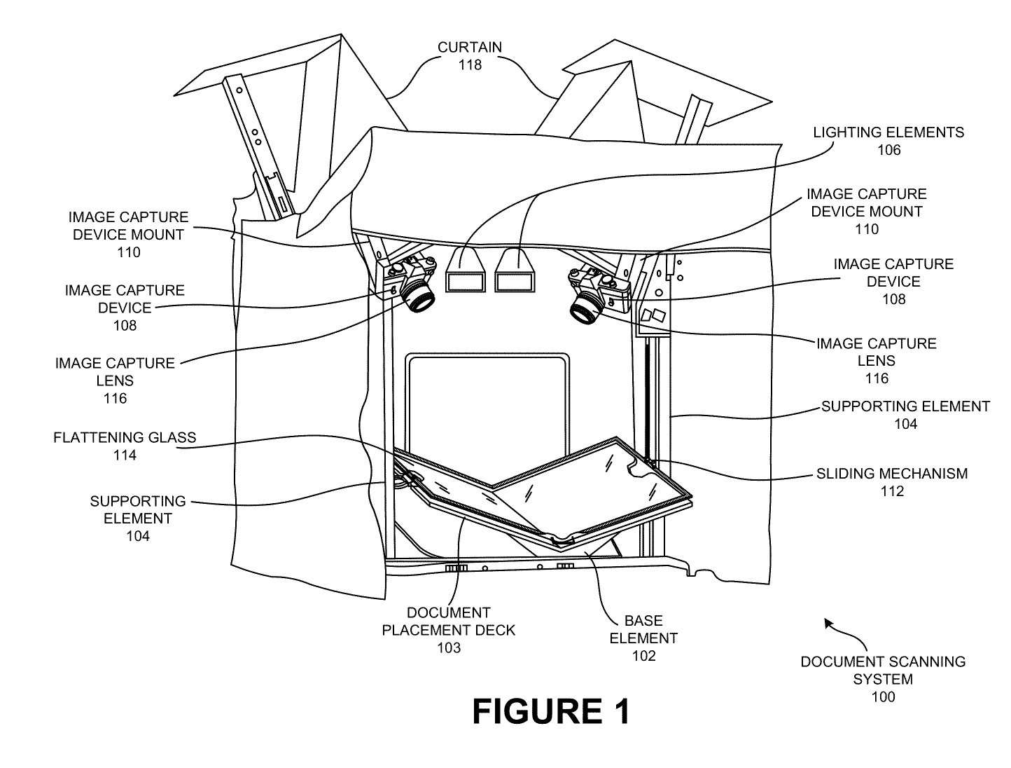

FIG. 1 illustrates a system view of a document scanning system 100, according to one or more embodiments. As shown in the example embodiment of FIG. 1, the document scanning system 100 may comprise a base element 102, a document placement deck 103 coupled to the base element 102 and positioned above the base element 102. The document scanning system 100 may also comprise one or more supporting elements 104 coupled to the base element 102 and one or more lighting elements 106 coupled to the one or more supporting elements 104. In one or more embodiments, the one or more lighting elements 106 may be non-planar and the one or more lighting elements 106 may emit a total light color temperature in the temperature range of 4,100 to 5,900 Kelvin. In these and other embodiments, each of the one or more lighting elements 106 may be positioned equidistant with respect to a center point on the document placement deck 103. Additionally, the one or more lighting elements 106 may generate a combined brightness output on a top surface of the document placement deck 103 of between 1,500 to 2,500 lux.

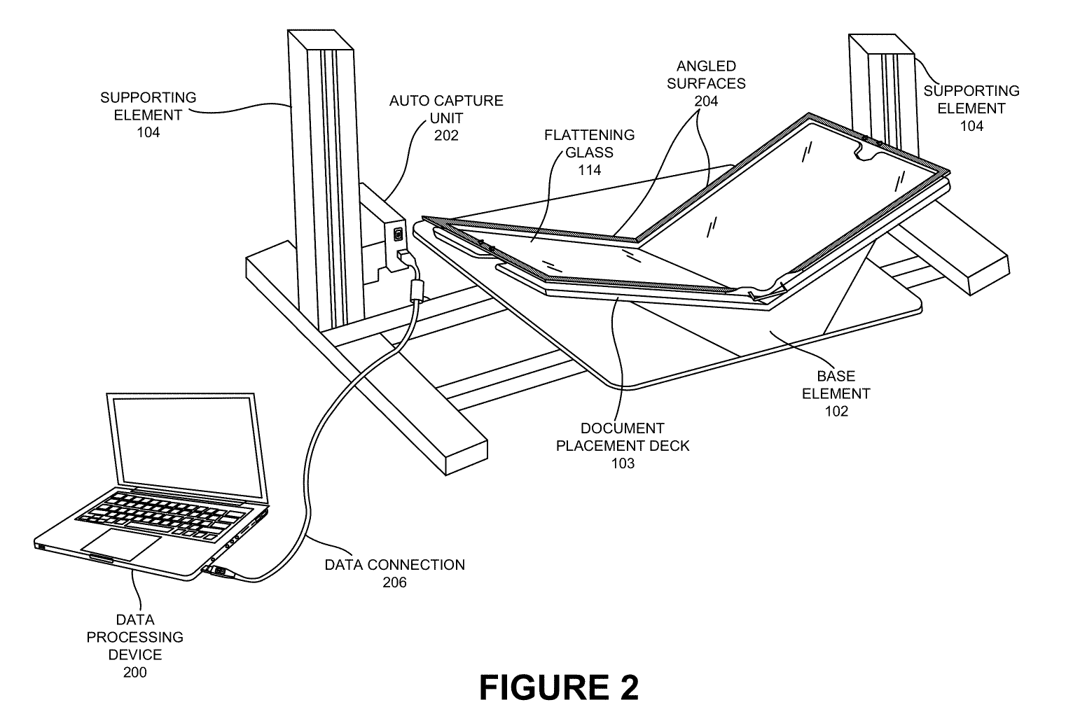

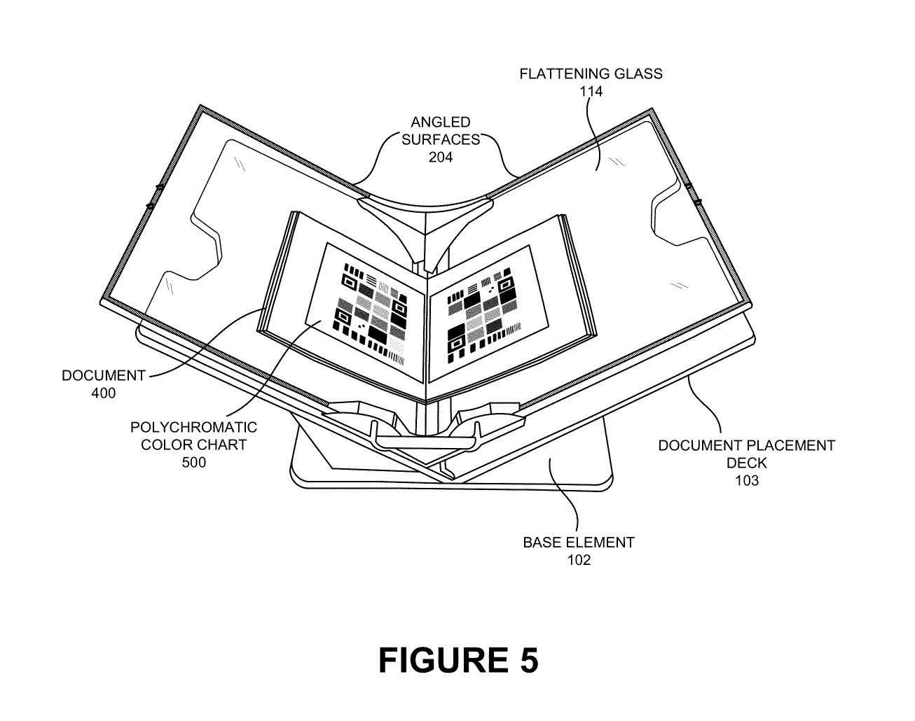

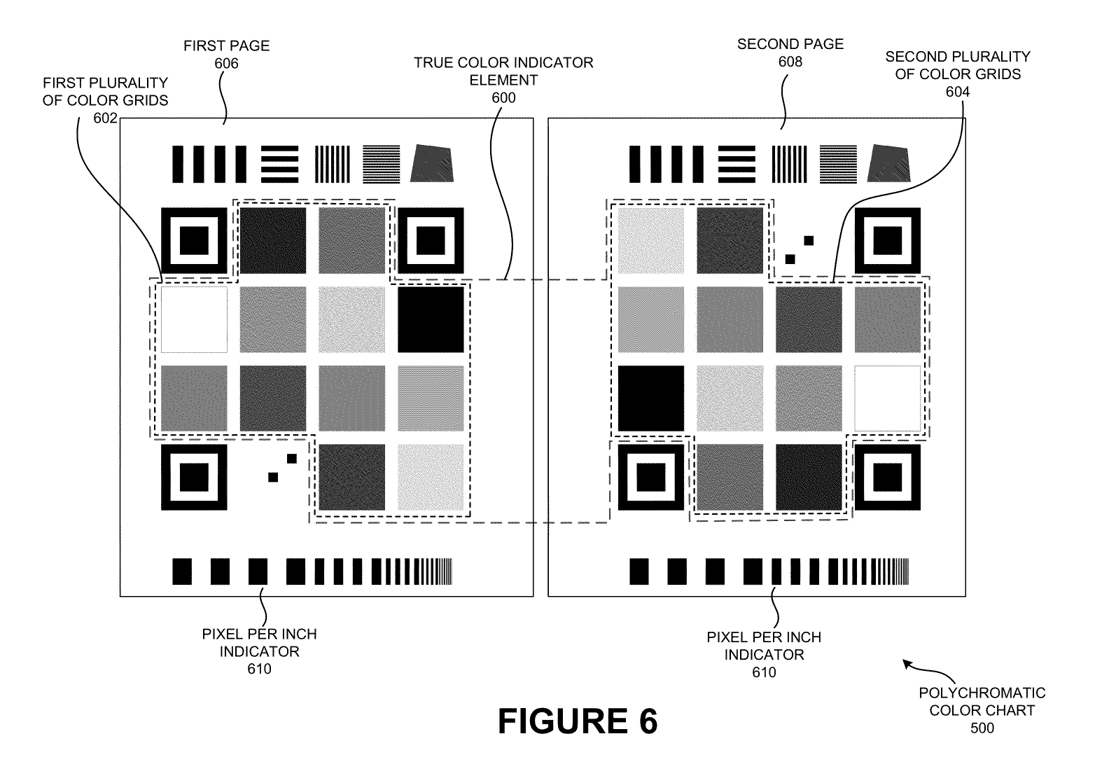

As shown in FIG. 1, the document scanning system 100 may comprise one or more image capture devices 108 coupled to the one or more supporting elements 104 by one or more image capture device mounts 110 positioned above the document placement deck 103. In all such embodiments, the one or more image capture devices 108 may be configured to capture an image of a document placed on the document placement deck 103. Moreover, the document scanning system 100 may comprise a polychromatic color chart 500 (see FIGS. 5 and 6) having a true color indicator element 600 (see FIG. 6). In one or more embodiments, a data processing device 200 (see FIG. 2) may be communicatively coupled to the document scanning system 100 and may be configured to use the polychromatic color chart 500 to determine a true color of the image captured.

As shown in FIG. 1, a curtain 118 may cover any portion of the one or more supporting elements, the one or more lighting elements 106, the document placement deck 103, and the base element 102 to provide a controlled lighting environment. In one embodiment, a portion of the curtain 118 may be constructed of a polymer-based material. In another embodiment, a portion of the curtain 118 may be constructed of a cloth-based material. In an alternative embodiment, a portion of the curtain 118 may be constructed of a metallic material. In yet another embodiment, a portion of the curtain 118 may be constructed of a combination of a polymer-based material, a metallic material, and a cloth-based material.

In one or more embodiments, the document placement deck 103 may be in a substantially V-shaped configuration with two angled surfaces 204 (see FIG. 2). As shown in FIG. 1, a flattening glass 114 in substantially the same shape as the document placement deck 103 may be coupled to the one or more supporting elements 104 through a sliding mechanism 112. In the embodiment shown in the FIG. 1, the sliding mechanism 112 may be coupled to the side of the flattening glass 114. In an alternative embodiment not shown in the figures, the sliding mechanism 112 may be coupled to the back of the flattening glass 114. In one embodiment, the flattening glass 114 may rest on top of the sliding mechanism 112 and may be configured to contact and flatten a document placed on the document placement deck 103.

In one or more embodiments, the one or more image capture devices 108 may be any of a smartphone, a digital camera, a tablet computer, a digital audio player, a personal digital assistant, a thin-client device, and any other type of personal computing device with image capturing functionalities. In the embodiment shown in FIG. 1, the one or more image capture devices 108 may comprise one or more image capture lenses and the one or more image capture lenses may be positioned toward at least one of the one or more angled surfaces of the document placement deck 103.

In one embodiment, a portion of the document scanning system 100 may be constructed of a polymer-based material. In another embodiment, a portion of the document scanning system 100 may be constructed of a silica-based material. In an alternative embodiment, a portion of the document scanning system 100 may be constructed of a metallic material. In yet another embodiment, a portion of the document scanning system 100 may be constructed of any combination of a polymer-based material, a silica-based material, and/or a metallic material.

FIG. 2 illustrates a close up view of the document scanning system of FIG. 1 communicatively coupled to a data processing device 200, according to one or more embodiments. As shown in FIG. 2, the data processing device 200 may be communicatively coupled to the document scanning system 100 through a data connection 206. In the embodiment show in FIG. 2, the data connection 206 may be a wired connection. In another embodiment not shown in FIG. 2, the data connection 206 may be a wireless connection. In one embodiment, the data processing device 200 may be communicatively coupled to the document scanning system 100 by first coupling to an auto capture unit 202 coupled to the document scanning system 100. In one or more embodiments, the data processing device 200 may be a desktop computer, a laptop computer, a tablet device, a thin-client device, a smartphone, a server, a workstation, and any of the aforementioned devices communicatively coupled to one or more of the aforementioned devices.

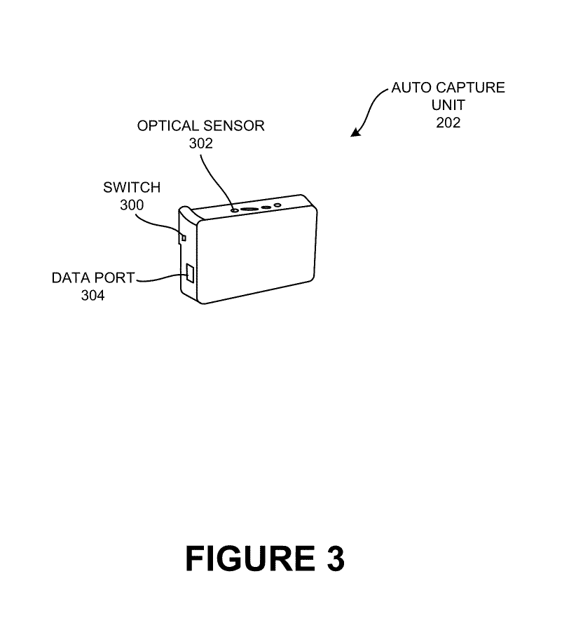

FIG. 3 illustrates a schematic of the auto capture unit 202 of the document scanning system 100 of FIG. 1, according to one or more embodiments. As indicated in FIG. 3, the auto capture unit 202 may comprise an optical sensor 302, a switch 300, and a data port 304. In one or more embodiments, the auto capture unit 202 may determine whether the user has lifted the flattening glass 114 to scan a new page of the document. The optical sensor 302 of the auto capture unit 202 may detect that the distance between the document placement deck 103 and the flattening glass 114 has changed (either by the user lifting up the flattening glass 114 or pushing down on the flattening glass 114). In either case, the auto capture unit 202 may inform the data processing device 200 that scanning must cease or re-commence once a change in the distance between the document placement deck 103 and the flattening glass 114 has been detected. The optical sensor 302 may be any type of light sensor capable of determining the luminosity of an image capture environment. In addition, the switch 300 may be a tactile switch, an electromechanical switch, a capacitive switch, a remote switch, and/or a sensor switch. Moreover, the data port 304 may be used to connect the auto capture unit 202 to the data processing device 200 over a wired or wireless connection. In these embodiments, a user may input instructions into the data processing device 200 to control the one or more lighting elements 106 and/or the one or more image capture devices 108 through the auto capture unit 202.

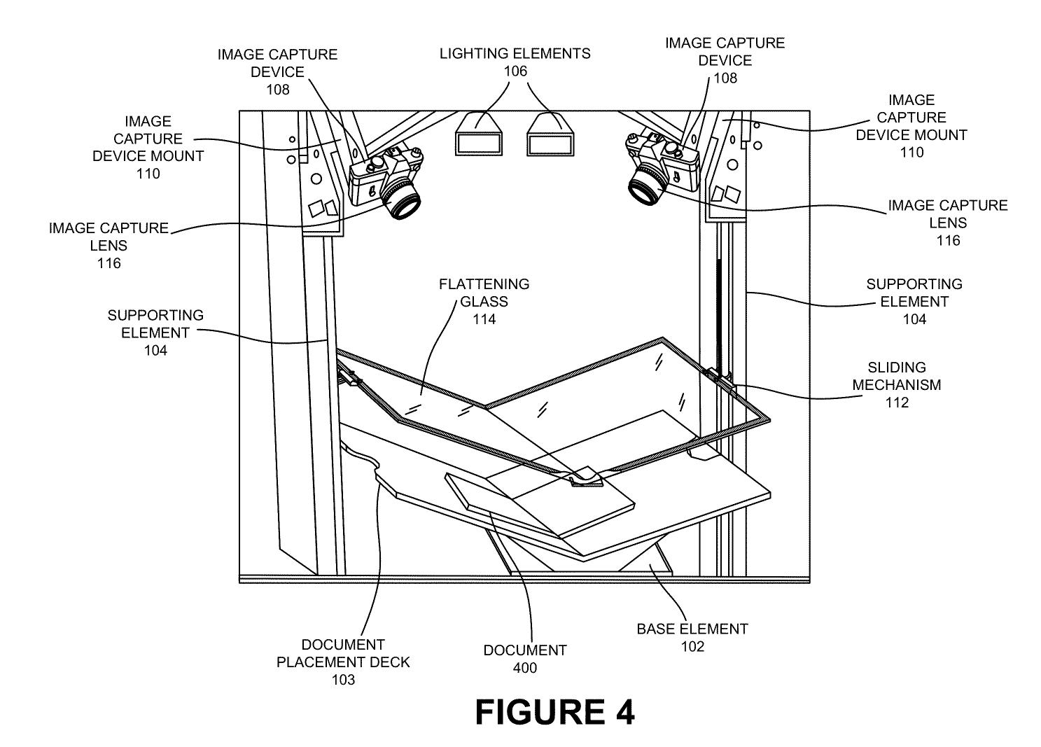

FIG. 4 illustrates the document scanning system 100 of FIG. 1 in operation, according to one or more embodiments. As shown in FIG. 4, one or more sliding mechanisms 112 may be coupled to the one or more supporting elements 104. Additionally, the sides of the flattening glass 114 may be coupled to the one or more sliding mechanisms 112 and a user of the document scanning system 100 may shift the flattening glass 114 up or down by applying a force on the flattening glass 114. In an alternative embodiment, the flattening glass 114 may be automatically shifted electronically without the application of force by the user. In one embodiment, the sliding mechanism may be a track mechanism. In an alternative embodiment, the sliding mechanism 112 may be a rolling mechanism. In all such embodiments, a document (such as the example document 400) may be placed on the document placement deck 103 and the flattening glass 114 may be configured to rest on top of the document 400 and to ensure that each page of the document 400 is at a substantially complimentary angle with respect to each of the one or more image capture lenses of each of the one or more image capture devices 108.

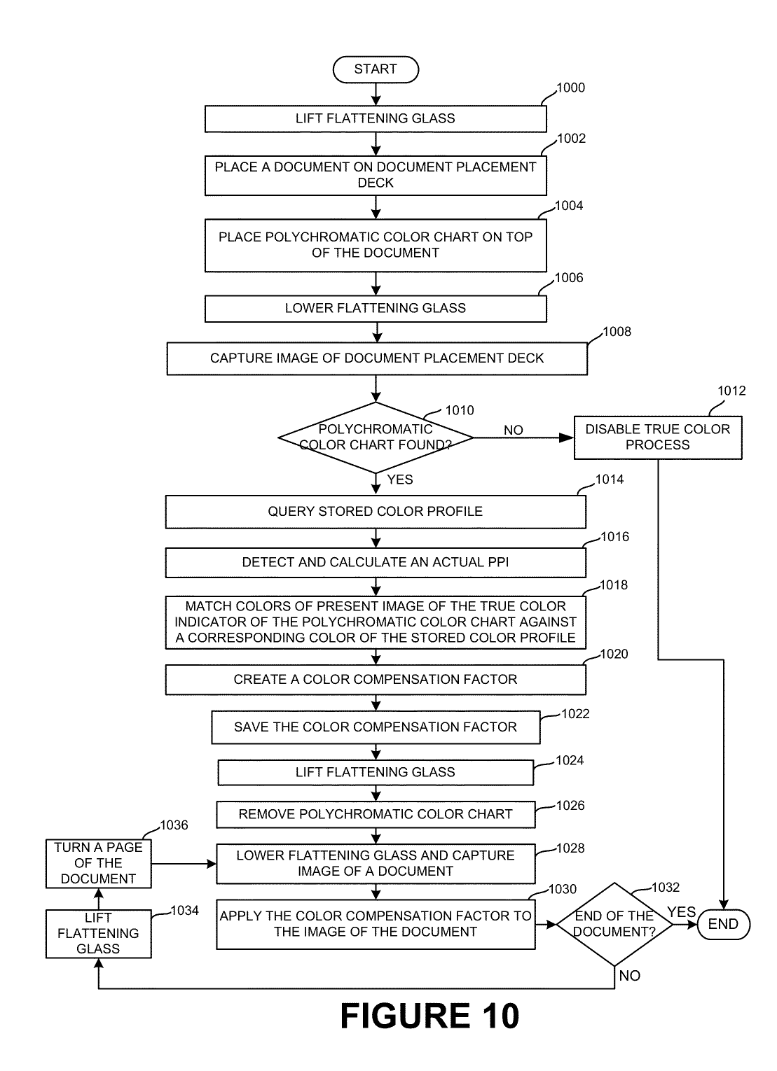

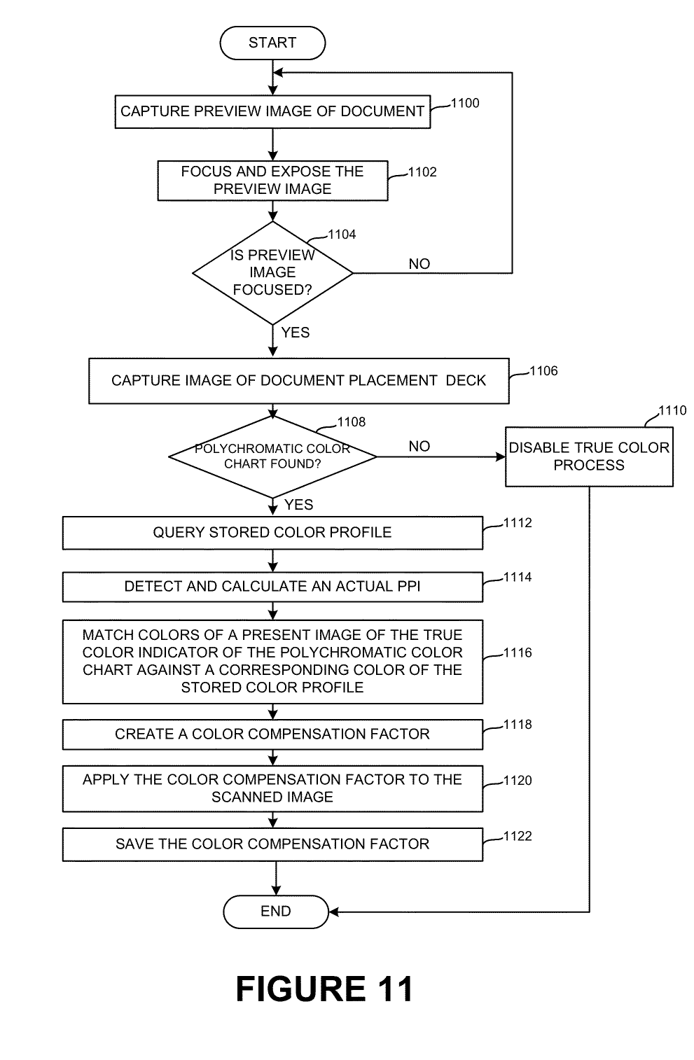

FIG. 5 illustrates an up close view of the document placement deck of the document scanning system of FIG. 1, according to one or more embodiments. As will be discussed in the flowcharts in FIGS. 10 and 11, a user may place the polychromatic color chart 500 on the document 400 when the flattening glass 114 has been lifted off of the document 400 and document placement deck 103. As shown in FIG. 5, the first page 606 (see FIG. 6) of the polychromatic color chart 500 may be placed on the left page of the document 400 and the second page 608 (see FIG. 6) of the polychromatic color chart 500 may be placed on the right page of the document 400. Once this is done, the user may rest the flattening glass 114 on both the polychromatic color chart 500 and the document 400. In an alternative embodiment not shown in FIG. 5, the polychromatic color chart 500 may be placed directly on the document placement deck 103. In yet another alternative embodiment, the polychromatic color chart 500 may comprise of only one page (either the first page 606 or the second page 608). In this embodiment, the polychromatic color chart 500 may be placed on either the left angled surface of the document placement deck 103 or the right angled surface of the document placement deck 103.

FIG. 6 illustrates, in color, an exemplary polychromatic color chart 500 used by the document scanning system 100 of FIG. 1, according to one or more embodiments. In one embodiment, the polychromatic color chart 500 may comprise a true color indicator element 600. In this and other embodiments, the true color indicator element 600 may comprise a plurality of colored grids. In one or more embodiments, the plurality of colored grids may comprise a red grid, a blue grid, a green grid, a cyan grid, a magenta grid, a yellow grid, and a key (or black) grid.

As shown in FIG. 6, the polychromatic color chart 500 may comprise a first page 606 and a second page 608. In this and other embodiments, the first page 606 may comprise a first plurality of colored grids 602 and the second page 608 may comprise a second plurality of colored grids 604. In this embodiment, the first plurality of colored grids 602 and the second plurality of colored grids 604 may combine to form the true color indicator element 600. Additionally, the first plurality of colored grids 602 may be arranged in a first grid arrangement. The first grid arrangement may be configured as shown in the example embodiment of FIG. 6. Furthermore, the second plurality of colored grids 604 may be arranged in a second grid arrangement where the second grid arrangement is the first grid arrangement rotated 180 degrees clockwise or counterclockwise. For example, as seen on the first page 606 of the polychromatic color chart 500 of FIG. 6, the first grid arrangement has the blue grid positioned in the second column of the first row and the key (or black) grid positioned in the fourth column of the second row of the first plurality of colored grids 602. As seen on the second page 608 of the polychromatic color chart 500 of FIG. 6, the second grid arrangement has the blue grid positioned in the third column of the fourth row and the key (or black) grid positioned in the first column of the third row of the second plurality of colored grids 604.

One motivation for the unique design of the true color indictor element 600 of the polychromatic color chart 500 may be to improve the true color detection process. As shown in FIGS. 1, 2, and 4, the substantially V-shaped document placement deck 103 comprising the two angled surfaces 204 may be ideal for scanning bi-fold type documents (e.g., books, magazines, pamphlets, etc.). However, as may be evident to one of ordinary skill in the art of bi-fold material scanning, the gutter (or spine-ward) region of most books, magazines, and pamphlets are often the most difficult to scan as the light pattern in such regions may be darker than the light pattern on regions further away from the spine. Given these conditions, a polychromatic color chart with the exact same color pattern on both the left (for example, the first page 606) and right (for example, the second page 608) pages may confuse the document scanning system 100 when the system has to determine which color of the true color indicator element 600 is the correct color. Thus, the document scanning system 100 requires a polychromatic color chart 500 that allows the system to differentiate between the colors presented on one page (for example, the left page) of the polychromatic color chart 500 over another page (for example, the right page).

One motivation for the rotated design of the second grid arrangement may be to ensure that each colored grid of the first plurality of colored grids 602 is the same as its corresponding color in the second plurality of colored grids 604. The rotation of the second grid arrangement may ensure that each pair of colors of the polychromatic color chart 500 are horizontally equidistant from the vertical gutter of the bounded material to be scanned (e.g., book, magazine, etc.) and are also vertically equidistant from the horizontal centerline of the bounded material to be scanned.

In one example embodiment, the document scanning system 100 may use the brightest color or the brightest RGB value detected on either the first page 606 (for example, the left page) or the second page 608 (for example, the right page) for each of the colors detected. In another embodiment, the document scanning system 100 may take the average RGB or color value of each of the colors detected on both pages (for example, taking the average of the yellow color value on both the left and right pages to determine the most accurate yellow color standard).

In one embodiment, a portion of the polychromatic color chart 500 may be constructed of a polymer-based material. In another embodiment, a portion of the polychromatic color chart 500 may be constructed of a paper or pulp-based material. In an alternative embodiment, a portion of the polychromatic color chart 500 may be constructed of a metallic material. In yet another embodiment, a portion of the polychromatic color chart 500 may be constructed of any combination of a polymer-based material, a paper or pulp-based material, and/or a metallic material. In one embodiment, the paper or pulp-based polychromatic color chart 500 may be laminated by a polymer-based laminate. As indicated in the example embodiment of FIG. 6, the polychromatic color chart 500 may also comprise one or more pixel-per-inch indicators 906.

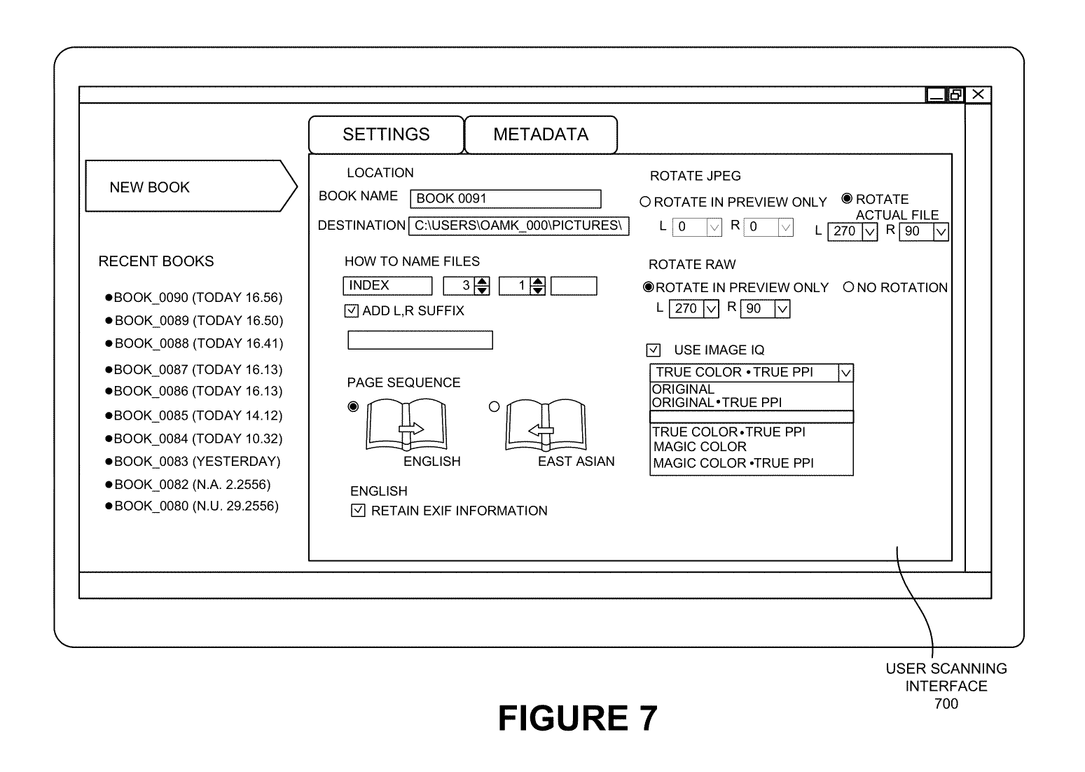

FIG. 7 illustrates an exemplary scanning program user interface 700 displayed on the data processing device 200 communicatively coupled to the document scanning system 100 of FIG. 1, according to one or more embodiments. In one embodiment, a user may manipulate a captured image by inputting commands through the scanning program user interface 700. As shown in FIG. 7, a user may select to apply a true color enhancement to an image captured by the document scanning system 100 or to determine a true pixel-per-inch of the image captured.

In one embodiment, the data processing device 200 may comprise a memory, one or more processors coupled to the memory, and an application or software program comprising a set of instructions stored in the memory, which when executed by the one or more processors, cause the data processing device 200 to perform operations associated with document scanning and true color enhancement of the document scanned. In one or more embodiments, these operations may include: capturing an image of the document along with the image's color profile, capturing an image of the true color indicator element 600, querying and retrieving a stored color profile from a color profile database stored in a memory or storage device of the data processing device 200 or a memory or storage device communicatively coupled to the data processing device 200; matching at least one color of the image of the true color indicator element 600 against a corresponding color of the stored color profile, creating a color compensation factor, and applying the color compensation factor to the image's color profile to enhance the true color of the captured image. In addition, the image capture device may be configured to store the color compensation factor in either the memory of the data processing device 200 or a storage device communicatively coupled to the data processing device 200 and apply the compensation factor stored to a new color profile of a new captured image. In one embodiment, the new captured image may be a captured image of a new page of a book being scanned by the document scanning system 100.

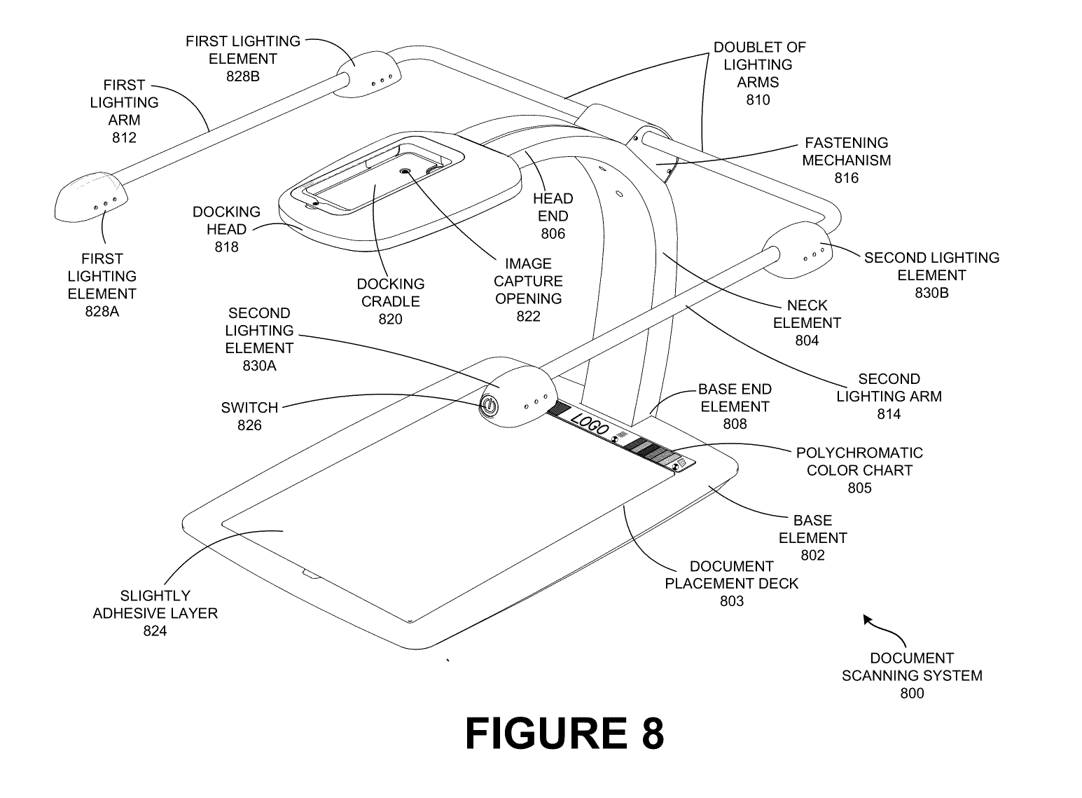

Reference is now made to FIG. 8, which is a perspective view of a document scanning system 800, according to one or more embodiments. In the embodiment shown in FIG. 8, the document scanning system 800 may comprise: a base element 802 comprising a document placement deck 803, a neck element 804 comprising a head end 806 and a base end 808 and coupled to the base element 802 at the base end 808; a doublet of lighting arms 810 coupled to the base element 802 and/or the neck element 804, a docking head 818 coupled to the head end 806 of the neck element 804 and having a docking cradle 820, and an image capture device positioned in the docking cradle 820 and having a user interface of the image capture device directed away from the document placement deck 803 and an image capture lens of the image capture device directed toward the document placement deck 803 through an image capture opening 822 of the docking head 818 to capture a scanned image.

As shown in FIG. 8, the doublet of lighting arms 810 may be coupled to the base element 802 and/or the neck element 804 through the fastening mechanism 816. In one embodiment, the neck element 804 may be positioned at a fixed distance from the document placement deck 803. In addition, the doublet of lighting arms 810 may also be positioned at a fixed distance above the document placement deck 803 and may comprise a first lighting arm 812 and a second lighting arm 814. In one embodiment, the first lighting arm 812 may comprise at least one first lighting element (for example, first lighting element 828A) and the second lighting arm 814 may comprise at least one second lighting element (for example, second lighting element 830A). As shown in the example embodiment of FIG. 8, the first lighting arm 812 may also comprise multiple lighting elements (for example, first lighting element 828A and first lighting element 828B). In addition, the second lighting arm 814 may also comprise multiple lighting elements (for example, second lighting element 830A and second lighting element 830B).

In the embodiment shown in FIG. 8, a switch 826 may be coupled to the first lighting arm 812 and/or the second lighting arm 814 to initiate or turn on the first lighting arm 812 and/or the second lighting arm 814. In one or more embodiments, the switch may be a tactile switch, an electromechanical switch, a capacitive switch, a remote switch, and/or a sensor switch. In one embodiment, the at least one first lighting element (for example, the first lighting element 828A and/or the first lighting element 828B) and the at least one second lighting element (for example, the second lighting element 830A and/or the second lighting element 830B) may be configured to generate a luminosity difference between the darkest portion of the scanned image and the brightest portion of the scanned image of between 0 to 25%. In addition, the at least one first lighting element (for example, the first lighting element 828A and/or the first lighting element 828B) may be positioned at a fixed distance from the image capture opening 822 and the at least one second lighting element (for example, the second lighting element 830A and/or the second lighting element 830B) may be positioned at a fixed distance from the image capture opening 822.

Moreover, the at least one first lighting element (for example, the first lighting element 828A and/or the first lighting element 828B) and the at least one second lighting element (for example, the second lighting element 830A and/or the second lighting element 830B) may be configured to emit a total light color temperature of between 4,100 to 5,900 Kelvin. In addition, the at least one first lighting element (for example, the first lighting element 828A and/or the first lighting element 828B) and the at least one second lighting element (for example, the second lighting element 830A and/or the second lighting element 830B) may be configured to generate a combined brightness output on a top surface of the document placement deck 803 of between 1,500 to 2,500 lux.

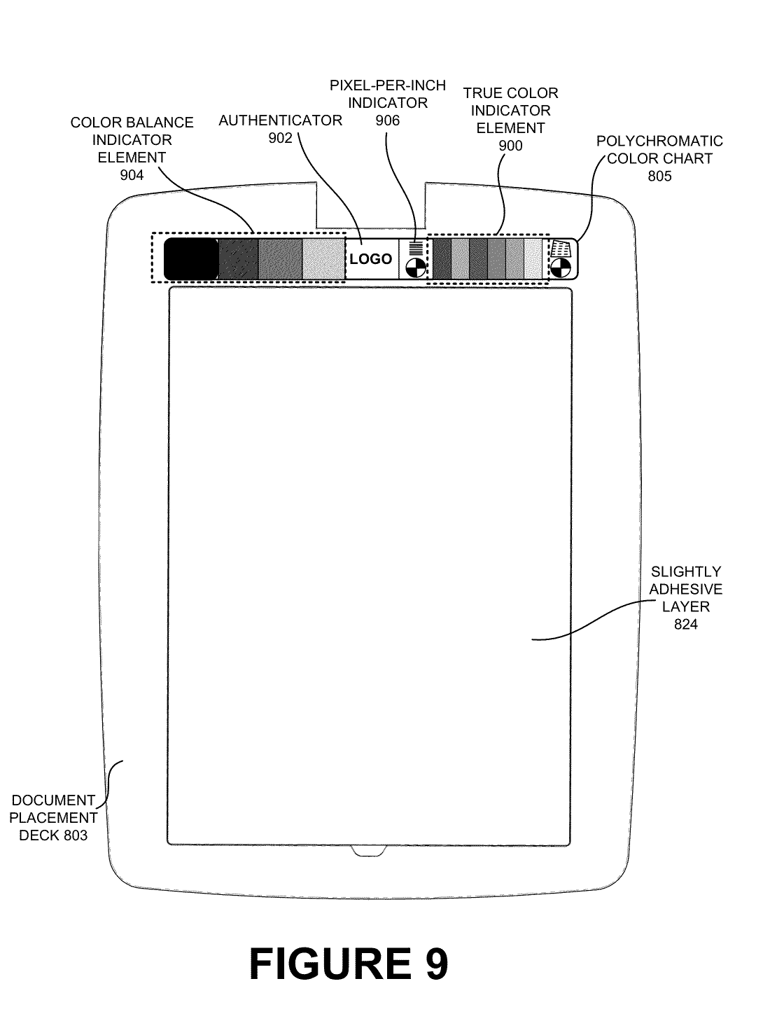

In one embodiment, the base element 802 may be inclined at an angle between 1 and 20 degrees. This incline may improve the lighting environment of the scanned image (e.g., by reducing glare and unwanted reflections) and improve the visibility of the document to the user. In these and other embodiments, the document placement deck 803 may comprise a slightly adhesive layer 824 (see FIG. 9) to hold a document in place. The slightly adhesive layer 824 may be designed so that removal of the document from the document placement deck 803 does not leave a residue on the underside of the document. In one embodiment, the document placement deck 803 may comprise a matte finish. The matte finish may prevent light from the lighting elements (for example, the at least one first lighting element and the at least one second lighting element) from reflecting off of the document placement deck 803 and causing glare to interfere with a scan.

In one or more embodiments, the position of the docking cradle 820 may not be aligned with the head end 806 of the neck element 804. Specifically, the skewed or non-aligned position of the docking cradle 820 may allow for an image capture component (e.g., the camera lens) of the mobile device to be directly above the center point of document placement deck 803. In these and other embodiments, the docking head 818 may comprise a docking port that charges a mobile device placed in the docking cradle 830 and allows the mobile device to communicate with a display unit through at least one of an adapter connection and a wireless network, wherein the display unit comprises at least one of a television, a monitor, a projector, and any other device capable of displaying an image. In one embodiment the docking head 818 may be removable. In another embodiment, the docking head 818 may comprise of a sensor which may automatically turn on the at least one first lighting element (for example, the first lighting element 828A and/or the first lighting element 828B) and the at least one second lighting element (for example, the second lighting element 830A and/or the second lighting element 830B) upon detecting the presence of the mobile device positioned in the docking cradle 820. Moreover, the sensor may turn off the at least one first lighting element (for example, the first lighting element 828A and/or the first lighting element 828B) and the at least one second lighting element (for example, the second lighting element 830A and/or the second lighting element 830B) upon detecting the removal of the mobile device from the docking cradle 820.

In one or more embodiments, the lateral dimension of the neck element 804 may measure between 50-100 mm. Moreover, the lateral dimension of the docking head 818 may measure between 150-250 mm from end to end. In addition, the lateral dimensions of the document placement deck 803 and the base element 803 may measure between 200-300 mm. The skewed vertical dimension, from any of the first lighting elements 828A and 828B to the base element 802 may measure between 250-350 mm. The vertical dimension, from the bottom surface of the base element 802 to the top of the docking head 818 may measure between 300-400 mm. In addition, the vertical dimension, from the document placement deck 803 to the top of the fastening mechanism 816 may measure between 400-500 mm.

In one or more embodiments, the vertical dimension from the document placement deck 803 to the doublet of lighting arms 810 may measure between 400-500 mm. Moreover, the vertical dimension of the document placement deck 803 at its highest point may measure 20-35 mm. The vertical dimension of the polychromatic color chart 805 may measure between 15-30 mm.

In one embodiment, a portion of the document scanning system 800 may be constructed of a polymer-based material. In another embodiment, a portion of the document scanning system 800 may be constructed of a silica-based material. In an alternative embodiment, a portion of the document scanning system 800 may be constructed of a metallic material. In yet another embodiment, a portion of the document scanning system 800 may be constructed of any combination of a polymer-based material, a silica-based material, and/or a metallic material.

FIG. 9 illustrates, in color, a document placement deck of the document scanning system of FIG. 8 comprising a polychromatic color chart, according to one or more embodiments. In one embodiment, the polychromatic color chart 805 may comprise a true color indicator element 900. In one or more embodiments, the true color indicator element 900 of the polychromatic color hart 805 may comprise a plurality of colored grids. In the embodiment showing in FIG. 9, the plurality of colored grids comprises a red grid, a green grid, a blue grid, a cyan grid, a magenta grid, and a yellow grid. In alternative embodiments, the plurality of colored grids may also include a key (or black) grid.

As indicated in FIG. 9, the polychromatic color chart 805 may also comprise an authenticator 902 (shown in FIG. 9 as a generic logo), a color balance indicator 904, and one or more pixel-per-inch indicators 906. In one embodiment, the polychromatic color chart 805 may be a polymer band or strip where each of the colored grids of the true color indicator element 900 is an individually colored polymer section. In an alternative embodiment, the polychromatic color chart 805 may be a paper-based band or strip where each of the colored grids of the true color indicator element 900 is an individually colored paper section. In this embodiment, the entire paper-based band or strip may be laminated by a polymer-based laminate.

In one or more embodiments, an image capture device may be positioned in the docking cradle 820 of the document scanning system 800 to capture a scan of a document placed on the document placement deck 803. In these and other embodiments, the image capture device may be any of: a smartphone, a digital camera, a tablet computer, a digital audio player, a personal digital assistant, a thin-client device, and a personal computing device. In one embodiment, the image capture device comprises a memory, a processor coupled to the memory, and a mobile application or software program comprising a set of instructions stored in the memory, which when executed by the processor, cause the image capture device to perform operations associated with document scanning and true color enhancement of the document scanned.

In one or more embodiments, these operations may include: capturing an image of the document, along with the image's color profile, and capturing an image of the true color indicator element 900, querying and retrieving a stored color profile from a color profile database stored in a memory or storage device of the image capture device or a memory or storage device communicatively coupled to the image capture device; matching at least one color of the image of the true color indicator element 900 against a corresponding color of the stored color profile, creating a color compensation factor, and applying the color compensation factor to the image's color profile to enhance the true color of the captured image. In addition, the image capture device may be configured to store the color compensation factor in either the memory of the image capture device or a storage device communicatively coupled to the image capture device and apply the compensation factor stored to a new color profile of a new captured image.

FIG. 10 is a flow chart depicting exemplary operations undertaken by the document scanning system 100 of FIG. 1, according to one or more embodiments. Specifically, operation 1000 may involve a user of the document scanning system 100 lifting the flattening glass 114 and placing a document on the document placement deck 103, according to operation 1002. In addition, operation 1004 may involve the user placing the polychromatic color chart 500 on top of the document and lowering the flattening glass 114, according to operation 1006. At this juncture, operation 1008 may involve the image capture devices 108 capturing an image of the document placement deck 103. Operation 1010 may involve an application of the data processing device 200 querying whether a portion of the image captured comprised an image of the polychromatic color chart 500. If the answer to this inquiry is no, the true color process can be disabled in operation 1012 and a scan of the document can be made without true color enhancements. Alternatively, at this point, the system may prompt the user to ensure that the polychromatic color chart 500 is placed correctly on the document placement deck 103. If the answer to this inquiry is yes, the data processing device 200 may then query and retrieve color data from a stored color profile. In addition, the data processing device 200 may be configured to detect and calculate an actual pixel-per-inch by analyzing one or more pixel-per-inch indicators 610 of the image of the polychromatic color chart 500, according to operation 1016. Furthermore, the data processing device may then match the colors of the present image of the true color indicator element 600 of the image of the polychromatic color chart 500 against the corresponding colors of the stored color profile, according to operation 1018. Operation 1020 may then involve the data processing device 200 creating a color compensation factor based on the match undertaken in operation 1018 and save the color compensation factor in a memory of the data processing device 200, according to operation 1022.

Once this is done, operation 1024 may involve the user lifting the flattening glass 114 again (according to operation 1024), removing the polychromatic color chart 500 (according to operation 1026), and lowering the flattening glass 114 to capture an image of the document using one or more of the image capture devices 108 (according to operation 1028). As indicated in operation 1030, the data processing device 200 may then apply the color compensation factor to the captured image of the document to enhance the true color of the captured image. At this point, the data processing device 200 may then query the user in operation 1032 whether the entire document has been scanned. If the answer to this inquiry is yes then the scanning process is complete, if the answer to this inquiry is no, then the flattening glass may be lifted again (as indicated in operation 1034) and the position of the document can be moved or a page in a book or magazine may be turned (as indicated in operation 1036) to continue the scanning process at operation 1028.

FIG. 11 is a flow chart depicting exemplary operations undertaken by the document scanning system 800 of FIG. 8, according to one or more embodiments. More specifically, operation 1100 may involve the image capture device capturing a preview image of a document when the image capture device is placed in the docking cradle 820 of the document scanning system 800. Moreover, operation 1102 may involve the image capture device focusing and exposing the preview image of the document. Furthermore, operation 1104 involves the processor of the image capture device querying whether the preview image is focused. If the answer to this inquiry is no, the process is re-started from operation 1100, if the answer to this inquiry is yes, the processor of the image capture device may instruct the image capture device to capture an image of the document placement deck 803 in operation 1106. Operation 1108 may involve the processor of the image capture device querying whether a portion of the image captured comprises the polychromatic color chart 805. If the answer to this inquiry is no (e.g., if the polychromatic color chart 805 is blocked by part of a large document), then the true color process may be disabled in operation 1110; if the answer to this inquiry is yes, then the processor of the image capture device may query a memory of the image capture device and retrieve color data from a stored color profile, according to operation 1112. In addition, the image capture device may be configured to detect and calculate an actual pixel-per-inch by analyzing one or more pixel-per-inch indicators 906 of the image of the polychromatic color chart 805, according to operation 1114. Furthermore, the image capture device may then match the colors of the present image of the true color indicator element 900 of the image of the polychromatic color chart 805 against the corresponding colors of the stored color profile, according to operation 1116. Operation 1118 may then involve the image capture device creating a color compensation factor based on the match undertaken in operation 1116. Moreover, the processor of the image capture device may apply the color compensation factor to the scanned image in operation 1120 and also save the color compensation factor in a memory of the image capture device, according to operation 1122.

In one or more embodiments, the process of calculating the color compensation factor may be accomplished through the following operations. In one example embodiment, the exposure shift values Ev(ch) in each channel of RGB may be calculated using the equation:

$$Ev ( ch ) = \frac{{\sum }_{i = 1}^{4} {G}_{i} ( ch ) - {G}_{i}^{standard} ( ch )}{4}$$

where Gᵢ(ch) is the RGB channel of the color gray in the polychromatic color chart (either the polychromatic color chart 500 or the polychromatic color chart 805). Gᵢ(ch) values may correspond to: (0,0,0), (80,80,80), (160,160,160), and (220,220,220). G^{standard} may be a standard gray color in the polychromatic color chart (either the polychromatic color chart 500 or the polychromatic color chart 805). The overall exposure shift value Ev_{avg} of the polychromatic color chart (either the polychromatic color chart 500 or the polychromatic color chart 805) may be calculated by using:

$${Ev}_{avg} = \frac{{\sum }_{i = 1}^{3} ( {G}_{i} ( r ) + {G}_{i} ( g ) + {G}_{i} ( b )}{9}$$

Images may then be color-balanced by using equation:

P^{e}(x,y,ch)=P(x,y,ch)−Ev_{avg}−Ev(ch)

and enhanced (or normalized) with:

$${P}^{en} ( x , y , ch ) = \frac{{P}^{e} ( x , y , ch ) - Min ( {P}^{e} ( ch ) )}{Max ( {P}^{e} ( ch ) ) - Min ( {P}^{e} ( ch ) )} \times 255$$

where P^{e}(ch) are the pixels of the image in channel RGB after color balancing and P^{en}(ch) are the pixels of the image after enhancing.
The final process of true color of each channel P^{t} may be computed using:

P^{t}(x,y,ch)=P^{en}(x,y,ch)−W(ch)

where, in one example embodiment, the white balance W(ch) in each channel of RGB may be calculated as:

W(ch)=C(ch)−C^{standard}(ch)

In this embodiment, C(ch) may be the RGB color of the image from the image capture device or the mobile device and C^{standard} may be the standard RGB color of the polychromatic color chart (either the polychromatic color chart 500 or the polychromatic color chart 805); Cᵢ(ch) values may correspond to (255,0,0), (0,255,0), (0,0,255), (0,175,239), (236,38,143), and (255,242,18). After color balancing, the color channel may be normalized to adjust the scale once again.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A document scanning system, comprising:
a base element comprising a document placement deck;
one or more supporting elements coupled to the base element;
one or more lighting elements, wherein:
the one or more lighting elements is non-planar and is coupled to the one or more supporting elements,
the one or more lighting elements emits a total light color temperature of between 4,100 to 5,900 Kelvin,
each of the one or more lighting elements is positioned equidistant with respect to a center point on the document placement deck, and
each of the one or more lighting elements generates a combined brightness output on a top surface of the document placement deck of between 1,500 to 2,500 lux;
one or more image capture devices coupled to the one or more supporting elements and positioned above the document placement deck and configured to capture a scanned image; and
a polychromatic color chart comprising a true color indicator element, wherein a data processing device communicatively coupled to the document scanning system is configured to use the polychromatic color chart to determine a true color of the scanned image.

2. The document scanning system of claim 1, wherein:
the document placement deck comprises one or more angled surfaces,
the one or more image capture devices comprises one or more image capture lenses, and
the one or more image capture lenses is positioned toward at least one of the one or more angled surfaces.

3. The document scanning system of claim 1, wherein:
a switch communicatively coupled to the one or more image capture devices, wherein the switch is configured to initiate the capture of the scanned image and the switch is at least one of a tactile switch, an electromechanical switch, a capacitive switch, a remote switch, and a sensor switch.

4. The document scanning system of claim 1, wherein:
the image capture device is at least one of a smartphone, a digital camera, a tablet computer, a digital audio player, a personal digital assistant, a thin-client device, and a personal computing device.

5. The document scanning system of claim 1, further comprising:
a flattening glass configured to contact and flatten a document positioned on the document placement deck.

6. The document scanning system of claim 1, wherein:
the true color indicator element of the polychromatic color chart comprises a plurality of colored grids.

7. The document scanning system of claim 6, wherein:
the plurality of colored grids comprises a red grid, a blue grid, a green grid, a cyan grid, a magenta grid, a yellow grid, and a key grid.

8. The document scanning system of claim 1, wherein:
the polychromatic color chart comprises a first page and a second page.

9. The document scanning system of claim 8, wherein:
the first page comprises a first plurality of colored grids and the second page comprises a second plurality of colored grids, wherein the first plurality of colored grids and the second plurality of colored grids is part of the true color indicator element.

10. The document scanning system of claim 9, wherein:
the first plurality of colored grids is arranged in a first grid arrangement, and
the second plurality of colored grids is arranged in a second grid arrangement, wherein the second grid arrangement is the first grid arrangement rotated 180 degrees clockwise or counterclockwise.

11. A document scanning system, comprising:
a base element comprising a document placement deck and a polychromatic color chart, wherein the polychromatic color chart comprises a true color indicator element;
a neck element, positioned at a fixed distance from the document placement deck, comprising a head end and a base end and coupled to the base element at the base end;
a doublet of lighting arms, positioned at a fixed distance from the document placement deck, comprising a first lighting arm and a second lighting arm, wherein:
the first lighting arm and the second lighting arm are coupled to at least one of the base element and the neck element and are positioned above the base element,
the first lighting arm comprises at least a first lighting element coupled to the first lighting arm and the second lighting arm comprises at least a second lighting element coupled to the second lighting arm;
a docking head coupled to the head end of the neck element and comprising an image capture opening and a docking cradle; and
an image capture device positioned in the docking cradle and having a user interface face of the image capture device directed away from the document placement deck and an image capture lens directed toward the document placement deck through the image capture opening to capture a scanned image.

12. The document scanning system of claim 11, wherein:
the image capture device comprises:
a memory,
a processor coupled to the memory, and
a mobile application comprising a set of instructions stored in the memory, which when executed by the processor, cause the image capture device to:
capture the scanned image having a captured color profile of the scanned image and capture a present image of the true color indicator;
query a stored color profile in a color profile database;
match at least one color of the present image of the true color indicator against a corresponding color of the color profile,
create a color compensation factor, and
apply the color compensation factor to the captured color profile of the scanned image to enhance the captured color profile of the scanned image.

13. The document scanning system of claim 12, wherein:
the image capture device is configured to store the color compensation factor in the memory and to apply the color compensation factor stored in the memory to a new captured color profile of a new scanned image.

14. The document scanning system of claim 11, further comprising:
a switch coupled to at least one of the first lighting arm and the second lighting arm to turn on the first lighting arm and the second lighting arm, wherein the switch is at least one of a tactile switch, an electromechanical switch, a capacitive switch, a remote switch, and a sensor switch.

15. The document scanning system of claim 11, wherein:
the first lighting element and the second lighting element is configured to generate a luminosity difference between the darkest portion of the scanned image and the brightest portion of the scanned image between 0 to 25%; and
the first lighting element is positioned at a fixed distance from the image capture opening and the second lighting element is positioned at a fixed distance from the image capture opening.

16. The document scanning system of claim 11, wherein:
the first lighting element and the second lighting element is configured to emit a total light color temperature of between 4,100 to 5,900 Kelvin; and
the first lighting element and the second lighting element is configured to generate a combined brightness output on a top surface of the document placement deck of between 1,500 to 2,500 lux.

17. The document scanning system of claim 11, wherein:
the true color indicator element of the polychromatic color chart comprises a plurality of colored grids.

18. The document scanning system of claim 17, wherein:
the plurality of colored grids comprises a red grid, a blue grid, a green grid, a cyan grid, a magenta grid, a yellow grid, and a key grid.

19. The document scanning system of claim 11, wherein:
the docking head is removable.

20. The document scanning system of claim 11, wherein:
the image capture device is at least one of a smartphone, a digital camera, a tablet computer, a digital audio player, a personal digital assistant, a thin-client device, and a personal computing device.
